(19) United States
(12) Patent Application Publication
(10) Pub. No.: US 2012/0117143 A1
(43) Pub. Date: May 10, 2012

(54) COMPUTERIZED SYSTEM AND METHOD FOR VERIFYING COMPUTER OPERATIONS

(76) Inventor: PAUL WILLIAM WATKINSON, Lifton (GB)

(21) Appl. No.: 13/103,051

(22) Filed: May 7, 2011

Related U.S. Application Data
(60) Provisional application No. 61/409,673, filed on Nov. 3, 2010.

(51) Int. Cl. G06F 15/16; G06F 15/173

(52) U.S. Cl. 709/203; 709/224

(57) ABSTRACT

The present invention is a computerized system used to verify a client server computer system operations or an individual computer system's operations. The client server embodiment of the system includes a server computer system that includes an output system, an input system, a memory system, a processor system, a communications interface and a communications system, an input system to input data into the client server computer system and an output system to display the processed data. There are also one or more client computer systems that include an output system, an input system, a memory system, a processor system and a communications system to communicate the data between the input system, the output system, the memory system, the processor system and the communications interface and a communications network. The individual computer system contains similar components and modules and there is also a method of use for both systems.

This application claims priority to U.S. Provisional Application 61/409,673 filed on Nov. 3, 2010, the entire disclosure of which is incorporated by reference.

### TECHNICAL FIELD & BACKGROUND

The present invention generally relates to a system and method for computer operations. More specifically, the invention is a system and method for verifying computer operations.

It is an object of the invention to provide a system and method for verifying computer operations that can be utilized in an individual computer system environment.

It is an object of the invention to provide a system and method for verifying computer operations that can be utilized in a client server computer system environment.

It is an object of the invention to provide a system and method for verifying computer operations that enables software programs to be written and run that are verifiable and provably correct.

It is an object of the invention to provide a system and method for verifying computer operations that is possible to prevent producing a software program which can be executed but which is not in a computable sequence.

It is an object of the invention to provide a system and method for verifying computer operations that enforces arithmetic concepts at the hardware level rather than at the software level to verify computer operations.

It is an object of the invention to provide a system and method for verifying computer operations that ensures that the functional decomposition of the arithmetic concepts involved with verifying the computer operations is hierarchical.

What is needed is a system and method for verifying computer operations that can be utilized in an individual computer system environment, that can be utilized in a client server computer system environment, that enables software programs to be written and run that are verifiable and provably correct, that is possible to prevent producing a software program which can be executed which is not in a computable sequence, that enforces arithmetic concepts at the hardware level rather than at the software level to verify computer operations and that ensures that the functional decomposition of the arithmetic concepts involved with verifying the computer operations are hierarchical.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a system overview of a computerized system for verifying computer operations, in accordance with one embodiment of the present invention.

FIG. 2 illustrates a block diagram of a client system used in the computerized system for verifying computer operations, in accordance with one embodiment of the present invention.

FIG. 3 illustrates a block diagram of a server system used in the computerized system for verifying computer operations, in accordance with one embodiment of the present invention.

FIG. 4 illustrates a block diagram of an individual computer system for verifying computer operations, in accordance with one embodiment of the present invention.

FIG. 5 illustrates a flow chart of a method for verifying computer operations, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

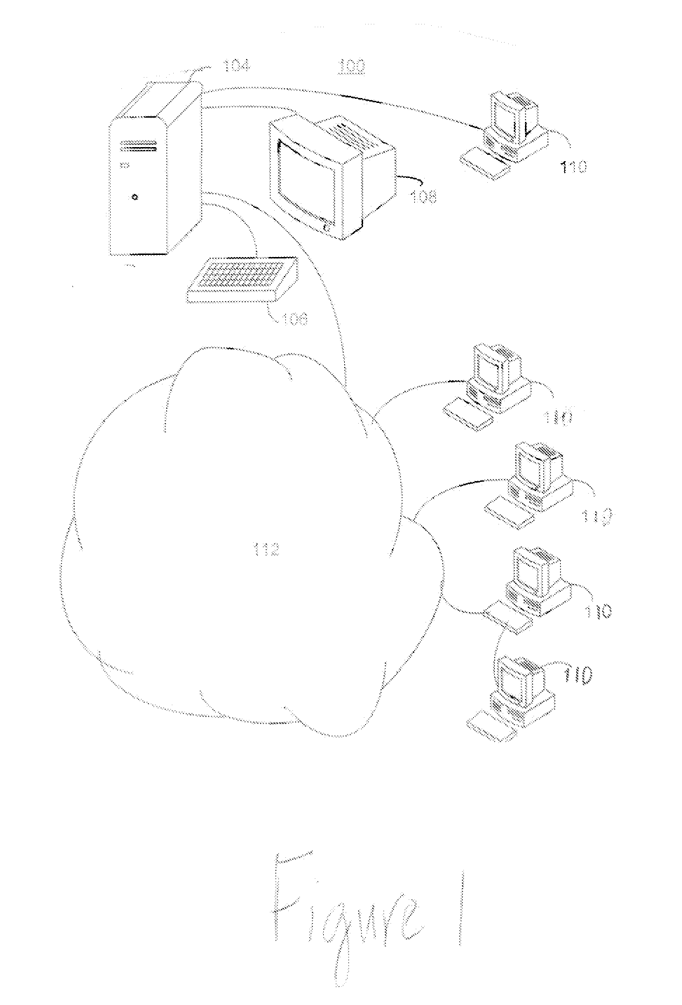

FIG. 1 illustrates a system overview of a client server computerized system for verifying computer operations 100, in accordance with one embodiment of the present invention. The client server computerized system for verifying computer operations 100 includes a server computer system 104, an input system 106, an output system 108, one or more client computer systems 110 and a communications network 112. The client server computerized system for verifying computer operations 100 may include additional components and/or may not include all of the components listed above.

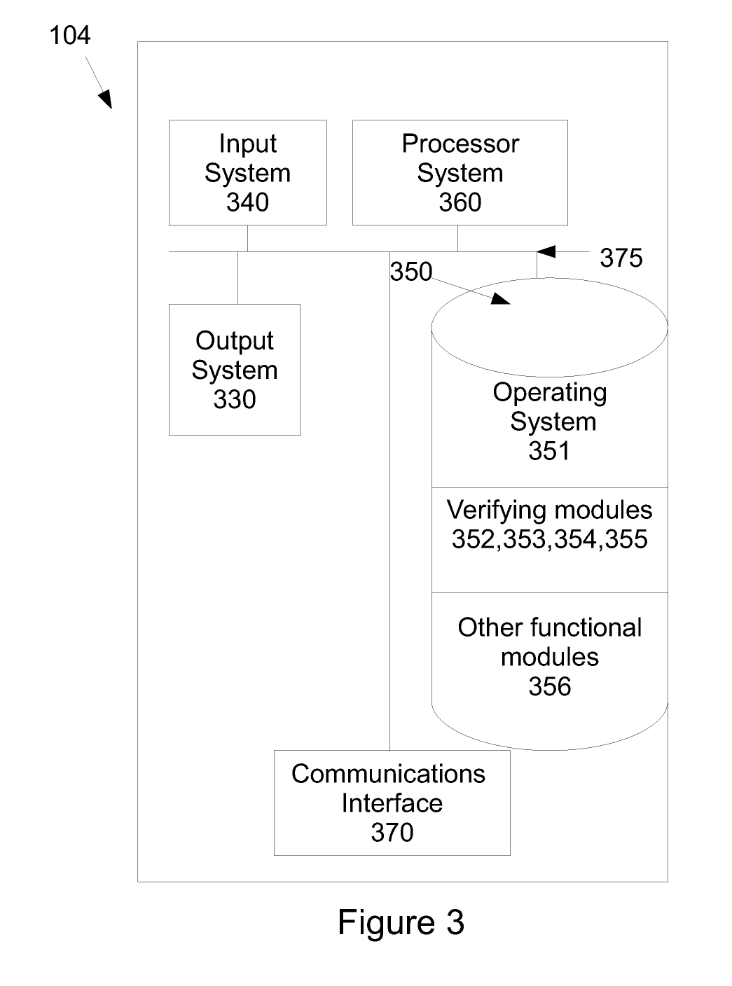

The server computer system 104 may have one or more servers. Details regarding the server system are outlined in FIG. 3 and its description. There is also an input system 106 that may include any one of, some of, any combination of, or all of a keyboard system, a mouse system, a track ball system, a track pad system, buttons on a handheld system, a scanner system, a wireless receiver, a microphone system, a connection to a sound system, and/or a connection and/or an interface system to a computer system, intranet, and/or the Internet, such as IrDA or USB technology.

There is also an output system 108 which may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, intranet, and/or the Internet.

The server computer system 104 may be directly connected and/or wirelessly connected to the client computer systems 110 which are connected via the communications network 112. The client computer systems 110 access the server system 104 via the communications network 112. The communications network 112 may be any one of, or any combination of, one or more local area networks (LANs), wide area networks (WANs), wireless networks, telephone networks, the Internet and/or other networks. The client computer systems 110 are any system that an end user may use to access the server computer system 104. The client computer systems 110 may be personal computers, workstations, laptop computers, net book computers, game consoles, handheld network enabled audio/video players and/or any other network appliance.

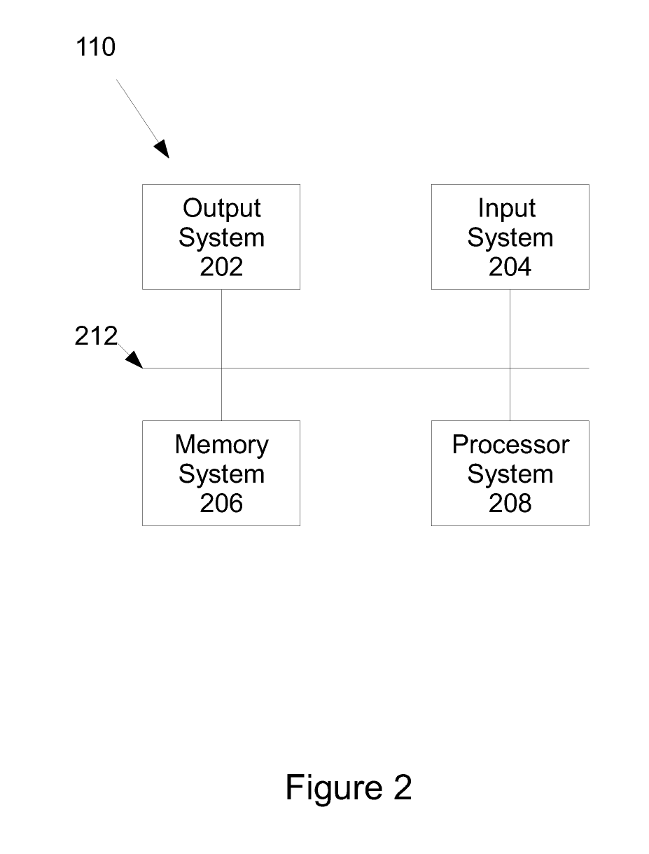

FIG. 2 illustrates a block diagram of a client system 110 used in the client server computerized system for verifying computer operations, in accordance with one embodiment of the present invention. The client system 110 may include an output system 202, an input system 204, a memory system 206, a processor system 208 and a communications system 212, such as a bus. The client system 110 may not have all of these components or may include additional components.

The output system 202 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, intranet, and/or the Internet, for example.

The input system 204 may include any one of, some of, any combination of, or all of a keyboard system, a mouse system, a track ball system, a track pad system, buttons on a handheld system, a scanner system, a wireless receiver, a microphone system, a connection to a sound system, and/or a connection and/or an interface system to a computer system, intranet, and/or the Internet, such as IrDA or USB technology.

The memory system 206 may include, for example, any one of, some of, any combination of or all of a long term storage system, such as a hard drive, a short term storage system, such as random access memory, a removable storage system, such as a floppy drive or a removable drive, and/or a flash memory. The memory system 206 may include one or more machine readable mediums that may store a variety of different types of information. The term machine-readable medium is used to refer to any medium that is structurally configured for carrying information in a format that is readable by a machine. One example of a machine-readable medium is a computer-readable medium.

The processor system 208 may include any one of, some of, any combination of, or all of multiple parallel processors, a single processor, a system of processors having one or more central processors and/or one or more specialized processors dedicated to specific tasks. The processor system 208 implements the programs stored in the memory system 206.

The communications system 212 communicatively links output system 202, input system 204, memory system 206 and processor system 208. The communications system 212 may include any one of, some of, any combination of, or all of electrical cables, fiber optic cables, and/or means of sending signals through air or water, such as wireless communications.

FIG. 3 illustrates a block diagram of a server computer system 104 used in the client server computerized system for verifying computer operations, in accordance with one embodiment of the present invention. FIG. 3 illustrates a block diagram of a server computer system 104 used for a client server computerized system for verifying computer operations 100. The server computer system 104 may include an output system 330, an input system 340, a memory system 350, a processor system 360, a communications interface 370 and a communications system 375. In other embodiments, the server computer system 104 may include additional components and/or may not include all of the components listed above.

The output system 330 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or Internet.

The input system 340 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or Internet, such as IrDA and USB technology.

The memory system 350 may include, for example, any one of, some of, any combination of, or all of a long term storage system, such as a hard drive, a short term storage system, such as random access memory, a removable storage system, such as a floppy drive or a removable drive and/or flash memory. The memory system 350 may include one or more machine-readable mediums that may store a variety of different types of information. The term machine-readable medium is used to refer to any medium capable carrying information that is readable by a machine, such as a computer-readable medium. There is also an operating system 351 included with the memory system 350 as well.

The processor system 360 may include any one of, some of, any combination of, or all of multiple parallel processors, a single processor, a system of processors having one or more central processors and/or one or more specialized processors dedicated to specific tasks. The processor system 360 may include one or more digital signal processors (DSPs) in addition to or in place of one or more central processing units (CPUs) and/or may have one or more digital signal processing programs that run on one or more CPUs.

The communications system 375 communicatively links output system 330, input system 340, memory system 350, processor system 360 and a communications interface 370. The communications system 375 may include any one of, some of, any combination of, or all of electrical cables, fiber optic cables, and/or sending signals through air or water. Some examples of sending signals through air and/or water include systems for transmitting electromagnetic waves such as infrared and/or radio waves and/or systems for sending sound waves.

The memory system 350 stores 4 modules that are utilized by the client server computerized system for verifying computer operations 100. These modules include a logic component module 352, a control component module 353, a primitives component module 354 and a hierarchy component module 355. The logic component module 352 will implement and execute arithmetic algorithms and three basic operations of logic, “and”, “or” and “no” at the hardware level to other modules 356 being executed through the operating system 351. The control component module 353 will read an entire sequence of functions 357 from the other modules 356 before execution to verify that the functional decomposition of the sequence of functions 357 is hierarchical, that for the functions 357 at any level there exists a formally equivalent function at the first level of that function 358 and that the sequence of functions 357 satisfy reflexive, symmetric, transitive and closed relationships and considers 0 as a natural number for the natural number applications of the sequence of functions 357 from the other modules 356. The control component module 353 then executes the computable sequence 358 of the sequence of functions 357 against the logic component module 352. The primitives component module 354 is part of the logic component module 352 and will then apply the basic levels of logic, “and”, “or” and “no”, which will represent the lowest element of the sequence of functions 357. Before the sequence of functions 357 is executed, the control component module 353 will request that the functional decomposition of the sequence of functions 357 is hierarchical, which is executed by the hierarchy component module 355, which is part of the control component module 353.

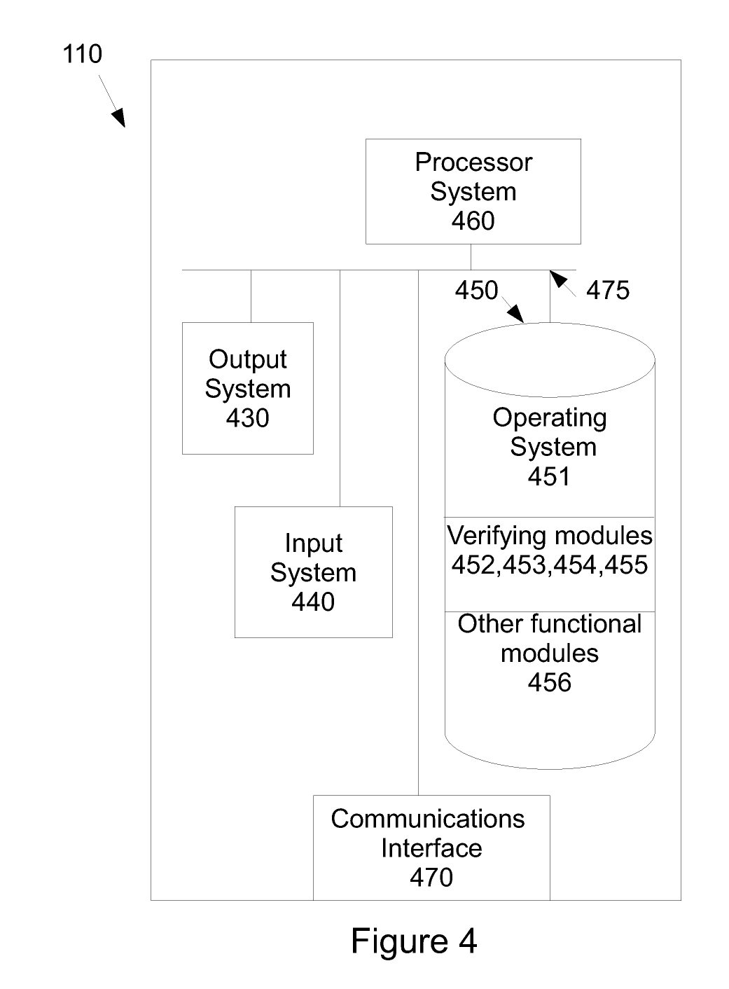

FIG. 4 illustrates a block diagram of an individual computer system for verifying computer operations 400, in accordance with one embodiment of the present invention. The individual computer system for verifying computer operations 400 is the approximately the same as the server computer system 104 described in FIG. 3. The individual computer system for verifying computer operations 400 includes an output system 430, an input system 440, a memory system 450, a processor system 460, a communications interface 470 and a communications system 475. In other embodiments, the individual computer system for verifying computer operations 400 include additional components and/or may not include all of the components listed above.

The output system 430 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or the Internet.

The input system 440 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or the Internet, such as IrDA and USB.

The memory system 450 may include, for example, any one of, some of, any combination of, or all of a long term storage system, such as a hard drive, a short term storage system, such as random access memory, a removable storage system, such as a floppy drive or a removable drive and/or flash memory. There is also an operating system 451 included with the memory system 450 as well. The memory system 450 may include one or more machine-readable mediums that may store a variety of different types of information. The term machine-readable medium is used to refer to any medium capable carrying information that is readable by a machine. One example of a machine-readable medium is a computer-readable medium.

The processor system 460 may include any one of, some of, any combination of, or all of multiple parallel processors, a single processor, a system of processors having one or more central processors and/or one or more specialized processors dedicated to specific tasks. The processor system 460 may include one or more digital signal processors (DSPs) in addition to or in place of one or more central processing units (CPUs) and/or may have one or more digital signal processing programs that run on one or more CPUs.

The communications system 475 communicatively links output system 430, input system 440, memory system 450, processor system 460 and a communications interface 470. Communications system 475 may include any one of, some of, any combination of, or all of electrical cables, fiber optic cables, and/or sending signals through air or water, such as wireless communications. Some examples of sending signals through air and/or water include systems for transmitting electromagnetic waves such as infrared and/or radio waves and/or systems for sending sound waves.

The memory system 450 stores 4 modules that are utilized by the client server computerized system for verifying computer operations 100. These modules include a logic component module 452, a control component module 453, a primitives component module 454 and a hierarchy component module 455. The logic component module 452 will implement and execute three basic operations of logic, “and”, “or” and “no” at the hardware level to other modules 456 being executed through the operating system 451. The control component module 453 will read an entire sequence of functions 457 from the other modules 456 before execution to verify that the functional decomposition of the functions 457 is hierarchical, that for the functions 457 at any level there exists a formally equivalent function at the first level of that function 458 and that the functions 457 satisfy reflexive, symmetric, transitive and closed relationships for the natural number applications of the functions 457 from the other modules 456. The control component module 453 then executes the computable sequence 458 of the sequence of functions 457 against the logic component module 452. The primitives component module 454 is part of the logic component module 452 and will then apply the basic levels of logic, “and”, “or” and “no”, which will represent the lowest element of the sequence of functions 457. Before the sequence of functions 457 is executed, the control component module 453 will request that the functional decomposition of the sequence of functions 457 is hierarchical, which is executed by the hierarchy component module 455, which is part of the control component module 453.

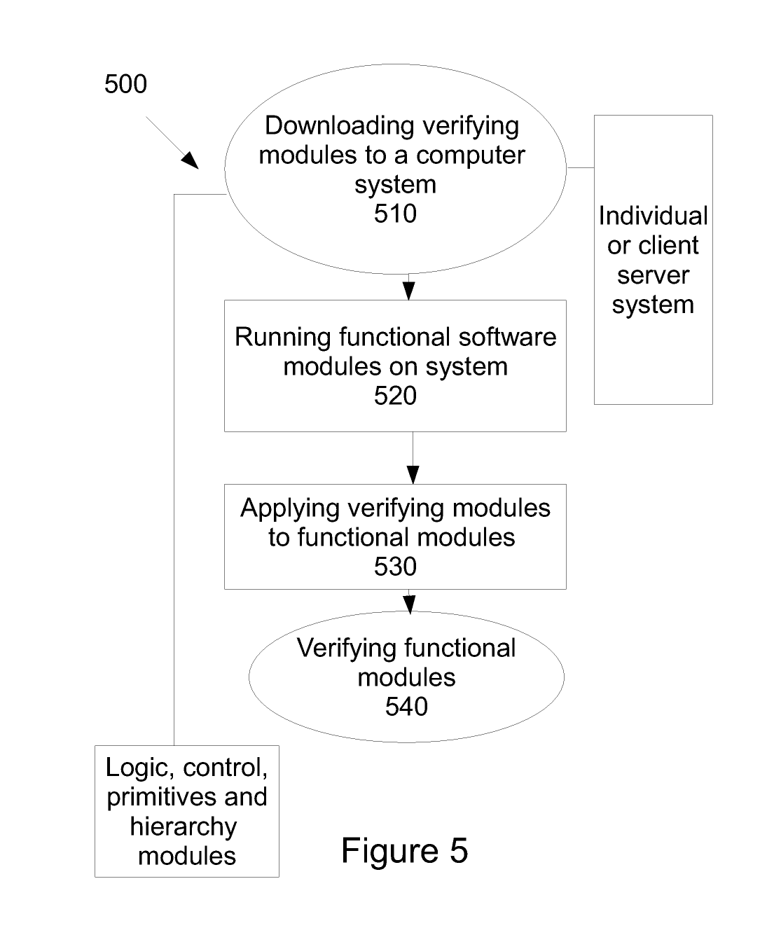

FIG. 5 illustrates a flow chart of a method for verifying computer operations 500, in accordance with one embodiment of the present invention. The steps of the method for verifying computer operations 500 include downloading verifying modules to a computerized system 510, running functional software modules on the computerized system 520, applying the verifying modules to the functional software modules and hardware of the computerized system 530 and verifying said functional software modules and hardware of said computerized system 540. The computerized system can be a client server computerized system for verifying computer operations, as described in FIG. 1 or an individual computer system for verifying computer operations, as described in FIG. 2. The verifying modules are a logic component module, a control component module, a primitives component module and a hierarchy component module. These verifying modules were previously described in the FIG. 3 and FIG. 4 descriptions and are utilized the same way in the method for verifying computer operations 500.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A computerized system used to verify a client server computer system operations, comprising:
a server computer system that includes an output system, an input system, a memory system, a processor system, a communications interface and a communications system;
an input system to input data into said client server computer system;
an output system to display said processed data;
one or more client computer systems that include an output system, an input system, a memory system, a processor system and a communications system to communicate said data between said input system, said output system, said memory system, said processor system and said communications interface; and
a communications network.

2. The system according to claim 1, wherein said memory system includes an operating system, a plurality of verifying modules and other functional modules.

3. The system according to claim 2, wherein said verifying modules include a logic component module with a primitives component module and a control component module with a hierarchy component module.

4. The system according to claim 3, wherein said logic component module implements and executes arithmetic algorithms and basic operations of logic at said computer system's hardware level and to said other functional modules.

5. The system according to claim 4, wherein said basic operations of logic are and, or and no.

6. The system according to claim 5, wherein said primitives component module applies said basic levels of logic to said computable sequences.

7. The system according to claim 3, wherein said control component module reads sequences of functions from said other functional modules and executes computable sequences of said sequence of functions against said logic component.

8. The system according to claim 7, wherein said hierarchy component module will functional decompose said sequence of functions.

9. The system according to claim 1, wherein said communications network is a local area network (LAN), a wide area networks (WAN), a wireless network, a telephone network or the Internet.

10. A computerized system used to verify an individual computer system operations, comprising:
an input system to input data into said computerized system;
an output system to display processed data;
a memory system with an operating system, a plurality of verifying modules and other functional modules;
a processor system to process said input data; and
a communications system to communicate said data between said input system, said output system, said memory system and said processor system.

11. The system according to claim 10, wherein said verifying modules include a logic component module with a primitives component module and a control component module with a hierarchy component module.

12. The system according to claim 11, wherein said logic component module implements and executes arithmetic algorithms and basic operations of logic at said computer system's hardware level and to said other modules.

13. The system according to claim 12, wherein said basic operations of logic are and, or and no.

14. The system according to claim 13, wherein said primitives component module applies said basic levels of logic to said computable sequences.

15. The system according to claim 11, wherein said control component module reads sequences of functions from said other modules and executes computable sequences of said sequence of functions against said logic component.

16. The system according to claim 15, wherein said hierarchy component module will functional decompose said sequence of functions.

17. A computerized method for verifying computer operations of a computerized system, comprising the steps of:
downloading verifying modules to a computerized system;
running functional software modules on said computerized system;
applying said verifying modules to said functional software modules and hardware of said computerized system; and
verifying said functional software modules and hardware of said computerized system.

18. The method according to claim 17, wherein said verifying modules include a logic component module with a primitives component module and a control component module with a hierarchy component module.

19. The method according to claim 18, wherein said logic component module, said primitives component module, said control component module and said hierarchy component module implements and executes arithmetic algorithms and basic operations of logic at said computer system's hardware level and to said functional software modules and will functional decompose said functional software modules.

20. The method according to claim 17, wherein said computerized system can be a client server computerized system or an individual computer system.
